(19) United States
(12) Patent Application Publication
(10) Pub. No.: US 2009/0147651 A1
(43) Pub. Date: Jun. 11, 2009

(54) SINGLE BEAM SYSTEM FOR WRITING DATA USING ENERGY DISTRIBUTION PATTERNS

(76) Inventor: Vitali Prisacar, Roswell, GA (US)

Correspondence Address: LEV INTELLECTUAL PROPERTY CONSULTING, 4766 MICHIGAN BOULEVARD, YOUNGSTOWN, OH, 44505, US

(21) Appl. No.: 12/315,770

(22) Filed: Dec. 5, 2008

Related U.S. Application Data
(60) Provisional application No. 61/007,028, filed on Dec. 7, 2007.

(51) Int. Cl. G11B 7/00

(52) U.S. Cl. 369/100; G9B/7

(57) ABSTRACT

A system for creating microstructures for data storage on a substrate employs a single modulated beam to write the data. The microstructures created can be in the form of lines created by a stylus constituted by a laser beam. Using the subject system, the individual microstructures can be configured to varying depths to achieve greater data storage capacity for the same surface area of substrate.

### PRIORITY INFORMATION

This Utility Application claims priority to Provisional Patent Application No. 61/007,028 filed on Dec. 7, 2007, incorporating it herein and making reference to same in its entirety.

### TECHNICAL FIELD

The present invention relates generally to techniques for the use of energy sources to transfer information onto selected substrates by contouring the substrate. More particularly, the present invention is directed to a system that can accommodate a wide variety of different data and different substrates in a highly flexible arrangement that can use energy patterns to create microstructures for image storage optical manipulation and encoding purposes.

### BACKGROUND ART

Energy sources have been used to contour substrates, usually to store data, or encode text on the substrate. One of the oldest examples is the heat-engraving of wood. Another example is the heat or chemical etching of metal, usually to make images or write text. Encryption using both text and images has been carried out using these techniques.

Far more complex data can be written in the form of miniature patterns on photo-resist coated substrates, one such example is the patterning used for printed circuits. Binary encoding can also be conducted using miniature structures or patterns. As these structures become smaller they are known as microstructures.

Image data can be converted to binary instructions for forming microstructure diffraction gratings (holograms), representing the original images. The sophistication (and miniaturization) of data writing systems has progressed to creating microstructures for compressing text or simple images. Microstructures are used to accommodate ever greater amounts of data with smaller formats, but this has lead to complications and limitations.

In the conventional art, considerable sophistication has been acquired with respect to manipulating substrates, including photoresist materials, to transfer data using energy patterns. Energy patterns store data by way of creating microstructures in or on the substrate. The complexity of the microstructures would determine the type of data and the configuration in which it can be stored, and accessed (displayed). These patterns can be provided from a wide range of energy sources, from electron beans to interfering monochromatic (laser) beams. However, such systems, (especially electron beams) can be complex, expensive and limited in capability.

One of the most popular systems for transferring or writing both text and image data is through the use of microstructures, such as those constituting the diffraction gratings of holograms. These holograms are composed of diffraction gratings formed or etched into a surface relief in a substrate. Conventional diffraction gratings for holograms are constituted by microstructures of a series of parallel, sharp-edged grooves or troughs having a particular range of sizes, depths and spacing. These microstructure grooves contain data representative of an original reflected or scanned image. One example of basic holography is found in U.S. Pat. No. 3,832,027, to King.

Advances in the computer analysis of original images (whether photographic or generated electronically) have permitted the capability for transferring or writing image information in much greater detail. Continuing computer advances in the control of scanners have permitted this image data to be conveyed to a photoresist substrate very quickly. However, when the image is taken as a whole or even in large segments, there are severe size limitations.

In order to address these drawbacks, the copying of images on a pixel-by-pixel basis was developed. This advance has been facilitated by the nature of microstructures. In this technique, an image is analyzed in a manner similar to standard rastering techniques to develop image information for each picture element, known as a pixel. The term pixel is recognized as standard terminology in all the video technology and the information contained in each pixel is usually dictated by one of a number of standard formats. Pixels also serve as a reference system for evaluating improvements in any microstructures.

A computer-controlled laser scanner permits writing of an image on a pixel-by-pixel basis, to store both image and text data. Each pixel derived from the original image is copied as a pixel-sized hologram constituted by a pattern of microstructure grooves. The scanning process allows the image data of each pixel to be configured as desired for the final product. The holographic pixels must be created by interfering beams of coherent light. Examples of systems using the pixel-by-pixel method are found in U.S. Pat. Nos. 5,822,092; 5,262,879; and 6,486,982. All of these are incorporated herein by reference.

The pixel-by-pixel method has enjoyed considerable success and has become a standard in the holographic industry. However, there are limitations in this technique, as well as other microstructure contouring techniques. This arrangement requires substantial expenditures of time in order to create a holographic image. Also, there are limitations on the data to be transferred, as well as the changes and modifications that can be made to that data during the copying or writing process that results in a microstructure used to store either text or image data.

The creation of pixels is not the only use to which micro-contouring can be put. However, it should be noted that many of the drawbacks found in the conventional art with respect to pixels is also found when micro-contouring is applied to create other types of structures. For example, any lack of precision or lack of speed is a detrimental in the creation of Fresnel lens as it would be for creating pixels for a hologram.

The conventional art puts severe requirements on many systems that can be used to create microstructures. For example, conventional holographic systems are required to operate with at least two beams of coherent light to create an interference pattern. This can be done on only limited types of substrates. This means that the substrate usually has to be a photoresist, or other photosensitive material and the substrate must be subject to a subsequent conventional etching process, as is used with all contouring of such materials. The standard pixel-by-pixel technique for creating holographic masters tends to be confined to use in the creation of a holographic master from which embossed copies are to be made. Due to the use of conventional interfering coherent beams, modification of individual pixels can be very difficult and time-consuming. Also, maximum use of the storage substrate cannot be approached due to the nature of conventional contouring techniques for microstructures such as holographic pixels, and the methods, of writing them.

Further, conventional techniques for writing pixels (the most common microstructure conventionally produced), are severely limited in the size and shape of microstructure that can be effected on a substrate. Very often microstructures require configurations or contours that are not normally produced in conventional pixel-forming systems. In particular, most conventional systems for producing pixels do so in the x and y axes over the surface of the substrate. Very little is done to contour the depth of the substrate in the direction of the z axis.

Some types of microstructures or data patterns require a more elaborate physical arrangement than that found with most conventional pixel-writing systems. Further, with most micro-contouring techniques, there are severe constraints. For example, electron beams require an extremely expensive and awkward system to conduct electron beam contouring within its required vacuum. Conventional laser contouring requires the use of masks. These are expensive and severely limit adjustments that can be made in the creation of microstructures. In photolithography (the most common conventional method of contouring microstructures), a mask is needed for each for specific pattern. To change the pattern, a new mask is required, an expensive and awkward process. Even if the masks are produced easily and quickly, they must be changed during the writing process, thereby greatly slowing the process.

Since conventional art techniques are only able to transfer data at a limited speed, and into a limited data configuration for the final product, substantial room for improvement exists in the conventional art of creating microstructures, such as holograms. Accordingly, an improved data writing system would overcome these drawbacks, creating greater speed, variety, and structure of data format than is presently available with the conventional art.

### SUMMARY OF INVENTION

Accordingly, it is a first object of the present invention to overcome the drawbacks of the conventional art, especially conventional surface micro-contouring arrangements.

It is a further object of the present invention to provide a data writing system that can provide additional data storage for a particular substrate area.

It is a further object of the present invention to provide a data writing system which does not require the use of masks.

It is an additional object of the present invention to provide a data writing system than can operate with a wider variety of receiving or storing mediums than is available with the conventional art.

It is yet another object of the present invention to provide a data writing system in which a wider variety of different data configurations are available than is available in conventional systems.

It is still an additional object of the present invention to provide a data writing system that can provide a more complex data configuration for a particular receiving or storing medium.

It is still a further object of the present invention to provide a data writing system which facilitates easy superposition of energy patterns for encoding multiple levels of data onto a medium.

It is yet another object of the present invention to provide a data writing system which contours a receiving or storing medium in a non-periodic configuration.

It is again a further object of the present invention to provide a data writing system capable of contouring a wide range of various structures, including profiling in 3-D, to reflect the programming of the writing system.

It is still an additional object of the present invention to provide a data writing system that permits the use of a wide variety of energy configuring and optical devices.

It is yet a further object of the present invention to provide a data writing system that can provide images of increased size over that available with the conventional art.

These and other goals and objects of the present invention are provided by a single laser beam system irradiating a line pattern for modulated contouring of substrate depth to form a selected relief pattern.

### BRIEF DESCRIPTION OF DRAWINGS

FIG. 1 is a schematic diagram depicting a generalized system for carrying out the process of the present invention, resulting in an inventive product.

FIG. 2 is a schematic representing the operation of the initial beam of the energy source, the resulting energy configuration.

FIG. 3 is a graph depicting energy density along the length of a radiation line.

FIG. 4 is a depiction of a local irradiation or writing area in which multiple groove lines are profiled onto a storage substrate.

FIG. 5 is a cross-sectional depiction of a storage substrate configured in accordance with one embodiment of the present invention.

FIG. 6 is a cross-sectional view of a storage substrate configured in accordance with another embodiment of the present invention.

FIG. 7(a) is a cross-sectional view of an irradiation pattern depicted in relationship a scanning field.

FIG. 7(b) is a cross-sectional view of an irradiation pattern, depicting penetration into an underlined substrate.

FIG. 8 as a top view of a scanning field such as that which could be used for irradiating a substrate.

### DETAILED DESCRIPTION OF THE PREFERRED EMBODIMENT

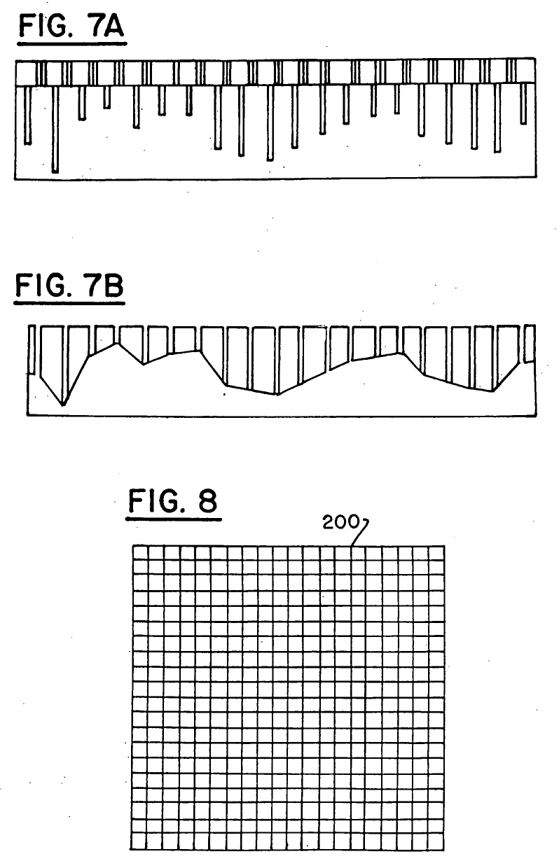

The present invention is directed to a process for contouring or forming a relief pattern in a substrate. This is done by using a modulated line of energy which has varying energy levels along its length. Typical examples of energy irradiation lines are depicted in 7(a) and 7(b). The modulated energy line depicted in FIGS. 7(a) and 7(b) can be swept in the direction of the y axis (as depicted in scan pattern 200 in FIG. 8) while maintaining the same energy levels along the x axis length of the line. However, the present invention also provides capability of changing various energy levels along the length of the line as the line is scanned in the y direction. The result is the capability of making virtually any shape of structure over the x y radiation pattern (as depicted in FIG. 8) and into the depth of substrate 19 (as depicted in FIGS. 7(a) and 7(b)).

The present invention is carried out using a typical system 100 (in FIG. 1), for writing selected data onto a particular storage substrate 19. The present invention is primarily directed to a method of using the inventive system, and to a final product having certain desirable characteristics, which result from the characteristics of the manufacturing process. Because of the inventive manufacturing process, a wide range of products become available, to such an extent that a full description of each product is not feasible for purposes of the present application. However, generic characteristics of the new products are fully described infra, and depicted in FIGS. 5 and 6.

A key attribute of the present invention is the use of a single energy beam 1 to mold, profile, contour, or ablate the selected storage substrate 19 that is to receive data for storage by being profiled in accordance with that selected data. The contouring or profiling of the substrate 19 is preferably done on a photo-resist material in a first embodiment. However, any kind of substrate can be used. This includes anything from photo-resist materials, to dichromated gelatin, to plastic or mylar, or even a metal substrate. In the first embodiment, the contouring or profiling takes the form of groove lines (in FIG. 4) constituting a diffraction grating.

The original data or information is expressed as an energy density distribution provided by manipulating a single energy beam E1 from energy source 1. Only a single energy beam E1 is used for configuring to data, the substrate 19 to store the data. This data storage can overcome the limitations of conventional pixels, and methods of writing them.

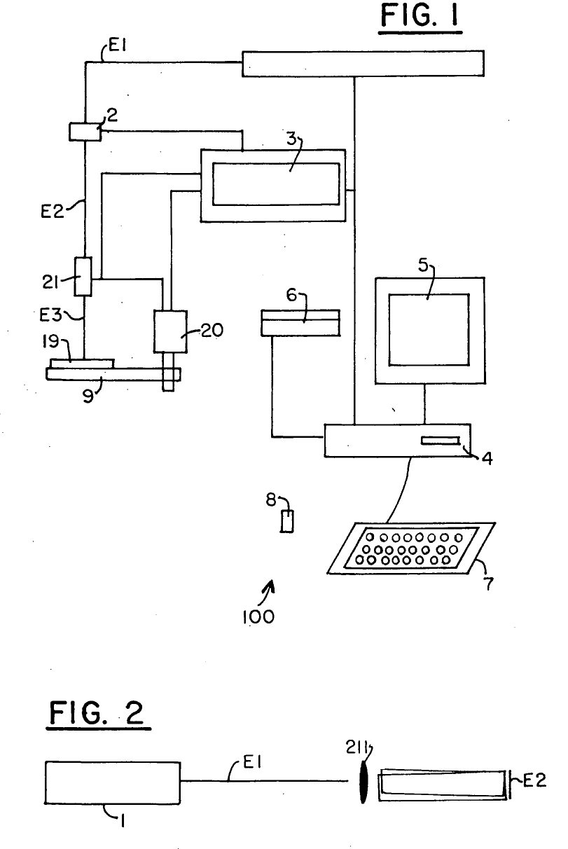

While the single energy beam E1 is preferably from a laser or other monochromatic light source 1, this is not necessary for the operation of the present invention. It should be noted that this is simply a first example of the present invention, in which a single laser beam profiling any appropriate surface 19 is used to replace the conventional two beam interference method, which is normally used to carry out the pixel-by-pixel operation. The use of a single beam is preferably in the form of a radiating line E2 (in FIG. 2) commonly known as a line source or line pattern. While a straight continuous, irradiation line E2 is the preferred method for configuring the single energy beam, other configurations, such as an arc or curve can also be used. A discontinuous line could also be used within the concept of the present invention.

In order to appreciate the final result of the single beam radiating line E2, conventional pixels should be considered as a frame of reference, although the present invention is not confined to the contouring of pixels. Holographic pixels are constituted by a diffraction grating, i.e.: a series of refracting grooves or troughs contoured or formed on the surface of the substrate 19. Conventional pixels are normally uniform in size. The entire diffraction grating structure (of each conventional pixel) is formed simultaneously.

In contrast, with the present invention the energy E1 from a source, such as a laser, must be shaped to create a line pattern (LP) E2 or a line irradiation pattern. One way to focus the beam on just one line is by having the circular or point beam E1 go through a cylindrical lens, contained in optical subsystem 2 (FIG. 1). Another way to create the line source E2 is to split the laser beam into a plurality of independent point sources and then optically focus those points together to form a line irradiation pattern. The resulting line irradiation pattern E2 essentially operates as a single beam, and is moved across the substrate 19 as such. In the conventional art, extreme focus and a mask are needed to simulate irradiation. As a result, the extent of the line is severely limited. This is not true with the present invention.

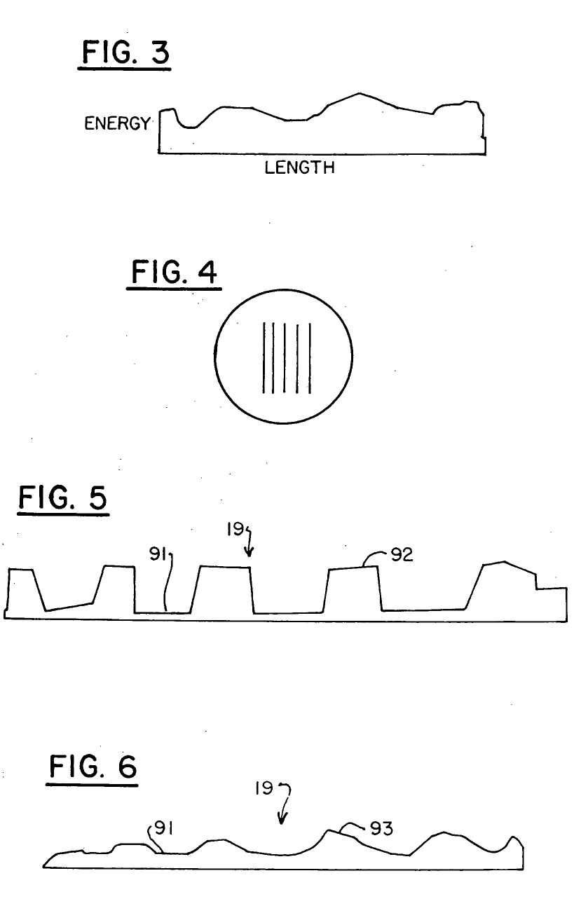

A wide variety of different energy types and sources fall within the concept of the present invention. Often, energy sources can be selected for a particular substrate to be profiled and for particular kinds of art to be copied. The present invention can be practiced with a line pattern E2 that is uniform in energy intensity across its entire length to profile a uniform line groove L as part of a diffraction grating. However, many advantages of the present invention are found by modulating the line pattern E2 along its length. This means that the energy level at different parts of the line pattern E2 is different at selected points along the line, as depicted in FIG. 3.

There are a number of ways in which modulation of the intensity of the beam E2 along a line pattern can be effected. One method is to project the image line pattern E2 through a light modulation device (included as part of optical subsystem 2). These are well-known in the optical arts and so not need be further described here for purposes of understanding the present invention. The light modulation device (part of optical subsystem 2) alters the energy density along the line in accordance with the digital information (programmed in processor 4 and translated in interface 3) that is to be used for profiling the depth of the substrate to store data.

The line pattern (LP) E2 can be moved to form additional lines L in a local writing area LWA (in FIG. 4) to further profile additional line grooves L in the LWA of the substrate 19. As the line pattern E2 is moved to another position in the LWA, it can be further modulated, changing the energy density at various points along the line pattern. This local movement of the line pattern can be construed as the expansion of what could be characterized as a line pixel (instead of the conventional dot or point pixel), since much of the data of an entire diffraction grating structure of a pixel can be contained in a single line L.

The present invention provides the capability of expanding the size of a conventional pixel through three dimensions by changing the energy density along any line L so that a different depth of substrate can be configured as desired to reflect the data to be expressed by the three dimensional profiling of the substrate. As a result, the present invention has the capability of creating a very complex contouring in what would otherwise be a uniformly contoured pixel area if using the conventional art. This arrangement also results in much greater data storage capacity.

It should be understood that a conventional pixel is constituted by a number of line grooves or gratings. The present invention can construct a standard pixel on a line-by-line or groove-by-groove basis. However, unlike conventional art where all grooves of a pixel are the same size, with a uniform energy density throughout individual grooves the present invention permits changing energy density from line to line, and along each line. The multiple lines can form a grating that would constitute a structure analogous to a conventional pixel. When using the present invention, data transfer is not limited in form to conventional pixels. Rather, a local writing area (LWA analogous to a pixel) can be enlarged or contracted in size (with respect to pixels or any other contoured structure), and can have a three dimensional variance in energy density to express stored data.

Each of the local areas (LWA) in which data is to be written (analogous to conventional pixels) can be configured in any way considered desirable to the configuration of data to be expressed in the profiling of the substrate. This can include image data, encoded data, and normal text. Thus, a conventional pixel can be replaced in the present invention by any of a single multi-energy density line, a multi-layered structure (3-D), or multiple grating lines.

The line irradiation pattern E2 can be moved locally within the selected local writing area (analogous of the area of a conventional pixel), creating a diffraction grating. The line irradiation pattern can also be rotated. This can be done by applying a standard optical image rotating element, like a prism, or any other optical element or any combination of the conventional optical elements. These are sufficiently well known in the optical arts so that further description is not necessary for an understanding of the present invention.

As a result, the standard diffraction grating of parallel grooves in the substrate is not imposed on the products created by the present invention. Rather, a far greater degree of adjustment of the data storing substrate is permitted by this rotational process within the selected local writing area, LWA in FIG. 4 which is analogous to a conventional pixel).

The present invention also permits the written area size to be varied as desired in both areas covered on the substrate and energy density variation throughout the written area. The written area can be further configured through the use of a standard mask or any sort of optical aperture, such as a shutter. This permits easy configuring of the groove line within the area selected for writing (corresponding to a conventional pixel). It also facilitates the compression of data into smaller spaces on substrate 19.

The writing system can be placed on a two-D/three-D motion or scanning system in order to be able to process selected profiling spaces of virtually any size. For example, a 60×60 inch substrate can be filled with data using the present invention. This is a substantial increase over the conventional art. When using vertically stacked (3-D) data writing, wherein data is expressed by various refractive elements stacked on each other, such a structure combines characteristics of both FIGS. 5 and 6.

In one mode of operation the irradiating line E2 is used to form a first groove, and then deactivated until it is redirected to the point where the next groove is to be formed. This intermittent or on-off operation is one mode of the function of the present invention and is similar to the on-off-scanning that is used in the conventional pixel-by-pixel method for forming holograms. Computer controlled switching mechanisms (controlled by digital interface 3) make the on-off operation sufficiently fast that there is not appreciable slowing between the use of the conventional pixel-by-pixel method and the inventive line pattern method of the present invention. The use of the intermittent or on-off operation for any energy source results in a sharp profiling of the grooves formed or profiled in the substrate. In some instances, this is desirable. However, in other applications sharp corners for the grooves are inappropriate. Sometimes, smoothly contoured surfaces are appropriate for the data to be copied onto the substrate. Conventional methods, such as the pixel-by-pixel method using a laser source, will not provide this capability. This limitation of the conventional art can be overcome by the present invention.

The system of the present invention can be adjusted to encompass a continuous activation of the irradiating line E2 as it is moved within the local writing area (LWA). Further, just as the energy density along the line of radiation E2 can be varied, the energy density of the radiation line can also be varied as the line is moved over the substrate from position to position L (as depicted in FIG. 4). This permits virtually any form or shape of contouring of the substrate without substantially slowing the process.

Further, because so many different types of information can be represented by highly complex contouring of the substrate, it is possible for more information to be copied more quickly and in greater density than with conventional methods. Also, because of the 2 axis contouring, substantial amounts of different information can be contained in the highly complex three dimensional contouring. Multiple layers of encoding or other types of information become possible without extending the substrate size. The information to be copied can be stacked by controlling the software (central processor 4) that originally compiles the information and using the same software to express different levels of information with different types of contouring of the substrate 19.

The drawings attached to this application depict a limited number of embodiments of systems used to carry out processes of the present invention. A description of all possible variations is impossible for purposes of teaching the present invention, but would occur to those skilled in the art applying the present invention to specific situations. The segments of the system depicted in the drawings are merely examples of techniques and components that can be used to carry out the present invention.

It should be understood that the present invention is not limited merely to the creation of holograms (only one preferred embodiment). Rather, the invention can be used to create many kinds of optics, including lens, diffusers and other micro optics.

One example is a Fresnel lens. When these are made by scribing (either mechanically, or with an energy source) the lens resulting is constituted by layers of sharp-edge structures formed through binary processes. However, with the present invention, the sharp edges can be formed as smooth curves. As a result, the final product has better optical characteristics than is possible when manufacturing lens (or other optical devices) using conventional binary processes.

FIG. 1 is a generalized schematic of a system that can be used to practice the present invention. This is an arrangement that is very similar to conventional arrangements for practicing the pixel-by-pixel method for making holograms. However, as already discussed holography need not be the only final product of the present invention. Rather, virtually any kind of optical product from diffraction grating to lens can be made using the present invention. Also, a wide variety of data writing for storage on various mediums or substrates can be carried out.

An energy source 1 is needed. As previously discussed, it can be a wide range of different types having different power levels, depending upon the nature of the profiling to be done, and the nature of the recording substrate 19 to be profiled. In a first preferred embodiment, the energy source is a laser selected to profile a photo-resist substrate 19.

The entire system is controlled by a central processor 4. This device can be anything from a microprocessor, to a laptop, to a “super computer”. Central processor 4 is controlled and even programmed using keyboard 7 and mouse 8. Input to the processor 4 as well as alternations being made for programming or control, is viewable using monitor 5. The central processor 4 can be run by standard graphic software (such as that used in pixel-by-pixel systems), modified to function for the present invention.

Scanner/image data base 6 is used to feed particular data (such as image data) to central processor 4. This data includes the image data to be copied onto substrate 19. Accordingly, image data base/scanner 6 can be any type of graphic imaging system that can provide an analysis of that data to be used by central processor 4 to provide instructions to the rest of the system with regard to the control resulting in the energy profile placed on substrate 19. This arrangement can be used for making optical elements, such as lenses, as well as images.

Because the complex profiling of the present invention admits to easily layering many types of information in the same local writing area (analogous to conventional pixel areas), the interfacing of the different data levels must be coordinated using a properly programmed central processor 4. This correlation of various types of data is also accomplished in digital interface 3 which is used to provide instructions to both the optical subsystems 2, 21, energy source (when needed) 1, and the motivator sources 20, used to move the movable platen 9 (in which substrate 19 resides) and optical subsystems such as 21. The digital interface 3 provides the necessary operating instructions to control each of the elements (1, 2, 21, 9) in accordance with the data to be written onto substrate 19.

Optical subsystem 2 is used to convert the single beam energy (usually a point or circle of radiation) E1 to a line pattern radiation E2. As previously discussed, this can be achieved using a number of techniques already well-known in the optical arts. Preferably, a cylindrical lens is used to accomplish this purpose since it is relatively simple. However, other techniques can be employed. Optical subsystem 2 can also modulate radiation pattern E 1 along its length, if desired.

Optical subsystem 2 includes a line moving mechanism for local movement (analogous to the general area of a conventional pixel) of the line within its selected local writing area (LWA). This can be accomplished with any well-known scanning device, including mirrors, prisms, and the like. Any moving parts can be mechanically adjusted using motivator system 20.

Optical subsystem 2 can also include provisions for rotating the irradiating line E2 when it is moved from point to point within the local irradiation area. This helps to facilitate the layering of different types of data within each local irradiation or writing area (LWA). During rotation of the line source, intermittent on-off operation can be used so that line irradiation takes place only at selected positions in the local writing area (LWA). In the alternative, irradiation can be continuous over the entire rotation of the line pattern. This provides for whatever type of contouring of the data to be copied might require.

It should be noted that the switching (on-off operation) of the line pattern radiation can be accomplished in any number ways. Firstly, the energy source 1 can be controlled to turn on and off. The facility for doing this depends largely on the characteristics of the energy source itself. For example laser pulsing systems are already well-known. With the present invention, the laser pulsing system is programmed to switch on the laser as a variety of different power levels to achieve profiling at different depths of the substrate. Another technique for effecting on-off operation can be accomplished by a shutter or mask arrangement contained in optical subsystem #2.

Further on-off operation can be accomplished using optical subsystem 21. Included therein could be a mask (not required), a light modulating device or even a shutter. A second modulating device, contained in optical subsystem 21, can be used to change the power of the irradiating line pattern as it is moved (from line position to line position) within the local writing area. The second line modulating device of optical subsystem 21 can be also used to change the shape and size of the local writing area (LWA) while contouring the substrate between line positions L (FIG. 4).

The motivating system 20 can be used to move the movable platen 9 for conventional x-y axis two dimensional scanning. The motivating system 20 can also be used to move the movable platen in three dimensions, if desired. The motivating system 20 can also be used to provide mechanical energy to move particular types of scanning devices in optical substantiate 21 if needed.

FIG. 2 is a schematic depicting a key operation of the present invention, generating a line pattern of radiation from an energy source 1. In the embodiment depicted, energy source 1 is a laser. A wide variety of different lasers (having different power levels and other characteristics) can be used as the energy source. The laser (or other energy source) selection is often a function of the type of substrate to receive the data.

The key attribute for the present invention is that the energy source be of a type that can be manipulated into a line pattern of radiation. While the radiation E2 (in FIG. 2) is a straight line in one preferred embodiment, it can be curved and still remain within the concept of the present invention. What matters is that a continuous radiation pattern be produced for purposes of transferring data from a central processor 4 (including scanner/data base 6) to a form that can be contained on substrate 19.

In the embodiment of FIG. 2, laser 1 radiates monochromatic light E1 in the same manner as conventional holograph writing systems. E1 is generally referred to as a point of radiation and is essentially circular in its cross-section. Lens 211 represents one option for turning circular laser beam into irradiation line E2. Any kind of modulation can be used as is appropriate for energy source 1 and the final shape of irradiation line E2.

While the present invention can be used with a uniform energy density along radiation line E2, a major advantage is obtained by further varying the energy density along radiation line L, as depicted in FIG. 3. Line L which results from radiation pattern E2 is defined by the graph of FIG. 3, in which the vertical axis represents energy, and the horizontal axis represents position along the radiation line L. A conventional modulation device (part of optical subsystem 2) can be used to effect the depicted energy density variation along line L. This provides another level in which data can be written for both holographic images and various levels of encoding within the holographic image. This provides an option not available with a uniform energy density irradiation line, or the uniform energy density of a conventional circular beam to write conventional holographic pixels.

FIG. 4 depicts a local writing or irradiation area (LWA) formed on substrate 19. Multiple grooves in the form of lines L are formed within the LWA in a manner analogous to a diffraction grating of a conventional pixel. However, with the present invention, each groove line L is formed individually rather than as a whole grating, as is done with a conventional pixel. Because of this, the desired variation in each groove line can be effected, as depicted in FIG. 3. As a result, additional data can be profiled onto substrate 19.

The cross-section of groove line L will reflect the energy density across the length of the line as depicted in FIG. 3. Preferably, this configuration is formed in a photo resist material which constitutes substrate 19. However, other materials can be profiled using the present invention. The additional levels of information writable with the present invention results from the individual writing of each groove line L, wherein each of the lines can have its own particular energy density configuration. Multiple groove lines L are written by profiling substrate 19 so that a local LWA can contain a plurality of grooves to form a diffraction grating such as that depicted in FIG. 5. Because the adjustment in energy density along each of these lines can be varied, additional variations in the resulting image and encoded data therein can be obtained.

It should be understood that the present invention provides an alternative to the convention pixel-by-pixel method. Conventional techniques provide pixels to represents image data, and occasionally encoded data hidden within the image. However, stacking information with conventional techniques is often problematical and can compromise the image, often indicating the presence of encoded data within the image.

The present invention, on the other hand, provides greater data variability and data storage capacity since it is not confined to pixels which are uniform throughout (indicative of only one pixel of the image). Rather, the grooves constituting the diffraction gratings are formed individually by the present invention and can be varied as desired by a programmer to indicate additional or encoded data within the holographic image. Further, the data storage capacity allowed by varying the energy density along a profiled groove line L, permits greater manipulation in configuring the final image for data represented. The LWA is not confined to the configuration of conventional pixels. Rather, it can contain more information or less, and can be much smaller or larger. Also, the LWA can be of virtually any shape as opposed to the circular conventional pixel.

Another key distinction between conventional pixels and the present invention is that each of the groove lines L can be rotated with respect to each other. This rotation can be effected by optical subsystems 2 or 21. As a result, the multiple lines can be perpendicular to one another, or any number of different angles. Further, the groove lines of profiling can cross each other if desired by the programmer, so that the intersections can provide additional encoding capability.

FIG. 5 depicts a diffraction grating formed using the present invention in which a laser irradiating line E3 is moved across a recording material at variable speeds and intensities to reflect sculpting or profiling of the surface. This process is usually part of an intermittent or on/off operation (of the energy source) in which a substantial part of the substrate 19 is profiled as troughs or grooves 91 and the surface 92 of the substrate is left relatively intact or un-profiled. The intermittent or on/off operation is characterized by the sharp corners and straight edges depicted in FIG. 5, and is commonly referred to as “binary operation”.

However, this need not be the result of the operation of the present invention. Rather, a different kind of profiling is possible, as depicted in FIG. 6. By continuous, modulated operation of energy source 1, and the optical subsystems 2, 21 a continuous, modulated energy beam E3 is provided to substrate 19. Besides providing further capacity for additional information to be written, this particular operation provides for the smooth transition between troughs 91 and peaks 93 of profiled substrate 19. While the configuration of FIG. 5 is more appropriate for some types of information, a profile of FIG. 6 is extremely useful in many other situations.

One such situation is the formation of Fresnel lens manufactured by the process of the present invention. Fresnel lenses and other diffractive optical elements (DOE) are made conventionally by scribing an appropriate substrate. Instead of mechanically scribing with a needle or stylus, the Fresnel lens can also be formed through ablation using a variety of appropriate energy source. However, when any optical element is made using either a laser or any other energy source, an intermittent or on/off process is employed. This means that straight lines and sharp interfaces will be result. In effect, a Fresnel lens made in this manner will simply be a collection of stacked, rectangular (or square) structures. This results in a certain level of distortion, and is one reason that Fresnel Lenses do not enjoy wider popularity.

Using the present invention, the value desired for a particular diffractive optical element can be converted into a gray scale value (using either image data base/scanner 6 and central processor 4). This value is then expressed by digital interface 3 as a series of instructions for contouring a substrate 9 in a particular physical configuration. As a result, the gray scale for a particular DOE is expressed by the intensity level of the physical characteristics of the contoured substrate. A change in the angular orientation of the energy being used to contour this substrate, the gray scale value of the DOE can be accurately controlled. This method can be practiced on a photo chemical substrate or by using ablation on a harder substrate (which is more difficult to contour). The important different between the product of the present invention and the convention art is that the sharp interfaces of straight surfaces found with the “binary” structures of the conventional art are modified by the present invention to include curves and even transitions. These can better reflect the desired optical characteristics, especially of an optical element such as a Fresnel lens.

A Fresnel lens constructed using the technique of the present invention, as exemplified in FIG. 6, will overcome many of the disadvantages of conventional Fresnel Lenses. In particular, the sharp edges between surface interfaces can be eliminated, thereby providing better optical characteristics. The contouring depicted in FIG. 6 can be controlled by a second modulating device, included as part of optical subsystem 21. Almost any kind of contouring is possible since energy density along line L can be adjusted as desired. Subsequent lines can be contoured whether parallel to the original line or at various angles. During the contouring, continuous irradiation can occur adjusting the energy density between line positions. The result is an almost unlimited scope of capability for writing in both image and textural data in three dimensions on a substrate. Because of computer control, appropriate instructions can be generated to control the optical subsystems 2, 21 as well as the energy source 1 to obtain the desired data configuration.

It is noted that changing the angular orientation of the radiating line can effect a smooth transition between surfaces in all directions. This means that a smooth contour can be achieved throughout any diffractive optical element. It also means that extreme structures such as smooth peaks, as depicted in FIG. 6, can also be easily achieved and without adding to the processing time for manufacturing the structure.

The present invention encompasses a method of creating both spectral (color) and non-spectral images. The present invention can also create multiple layers of data such as text, either in image form or various forms of encoding.

Virtually any energy source can be used, as long as it can be manipulated into an irradiating line. In one preferred embodiment, a laser is used. However, other light sources are appropriate. The energy source and its power level will be determined depending upon the substrate surface to be contoured.

Using the present invention, a pixel, pixel-like area or pseudo-pixel can be created by contouring the substrate on a line-by-line basis to form a diffraction grating in a local writing area (LWA). These local writing areas can be changed in size from one to another or changed in shape. Further, the lines which are contoured into the substrate need not be parallel. Unlike conventional diffraction gratings, each line can change in depth and width in order to express the desired optical characteristics. Further, the distance between adjacent lines can also be altered in any manner desired. This means that the color can be adjusted at any point in the image being written on the substrate. By making the aforementioned adjustments, all possible characteristics of the resulting image can be manipulated as desired.

As part of the manipulation, the profile of the line can range from a square trough (like those created in convention diffraction gratings), to triangular or saw-tooth configurations. The depths of the line structures can vary, as a whole, from line to line, or along each line. This is especially effective for controlling local brightness levels of the resulting image. Further, “binary” structures (with straight perpendicular surfaces and sharp interfaces) need not be the result. Rather, using the present invention, curved profiles can be used to further configure the resulting written image, other data, or optical structure.

The aforementioned minute adjustments in both local characteristics and the overall image are particularly important for manipulating for the resulting image for esthetic purposes. One technique for affecting the esthetics of the resulting image is to use a curved line rather than a straight line. This can alter the overall effect of the resulting image, as well as providing another level in which encoded data can be added to the final profiling of the substrate.

It is noted that both local and general image characteristics can be easily adjusted using techniques that are easily provided by the present invention. For example, the distance between lines is approximately one micron or less, splitting of white light into spectral components will occur. This is normally referred to as a diffraction grating. In the present invention, this adjustment can easily be made between normal, visible image lines and diffraction grating lines. Thus, the two types of image can be superimposed for both esthetic and encoding purposes.

Other adjustments are easily possible using the present invention. For example, by rotating the orientation of individual lines, the viewing or playback angle of the resulting image can also be adjusted. As a result, it is easy to make one image seen from one angle of the resulting contoured substrate, and another image from another viewing angle of the contoured substrate. Resulting images can be further complicated by juxtaposing local writing areas. This can be done by simply rotating the orientation of the lines being contoured into the surface of the substrate. Further, by changing the distance between the lines, the reflected light can be focused or spread out in a specific manner.

Adjusting the characteristics of an image can also be a way of adding another level of encoding. One example is that by changing the line length within a given writing area, an additional binary code can be created. A change in light distribution, either along a particular line or group of lines, or from line to line, can also be used to create another level of coding. This can also be used to create a secondary image based solely on an enhanced bright outline. It should also be understood that by using light modulation along a single irradiating line, a binary code can be created within that line. Any of the lines or grooves formed in a substrate can be used to provide additional encoded data if so desired.

Since the present invention provides easy writing of non-periodic structures such as diffractions gratings, diffusers, and directional optical elements an additional level encoding can be achieved based upon distances between lines, or angles between lines.

The use of non-periodic structures also provides the possibility of a “directional pixel”, which is a local writing area that by itself will be able to focus reflected or transmitted light into a point, a line or any other shape. The use of the so-called “directional pixel” means that a local writing area or portion of such a local writing area provides the capability of containing a “hidden (laser viewable only) image”. On the other hand, the “directional pixel” can be used to spread light into a cone or vertical line, forming a “color locked pixel” so that the vertical angle of view for a specific color will be much larger than can be achieved with a conventional pixel formed by the interference of two beams.

It should be understood that brightness and intensity can be controlled by changing the depth of the trough formed in the substrate by the irradiating line. The color spectrum can be controlled by changing the period or distance between lines forming the diffraction grating. The present invention provides the capability of easily changing the distance between grooves or troughs in the substrate from groove to groove to provide the desired image effect or encoding. This is not accomplished on a line-by-line basis with conventional pixels.

Viewing angle is adjusted by rotating the irradiating lines which can be used to overlap and intersect troughs, grooves or other configurations already contoured into the substrate. The use of the viewing angle can also be used as an encoding means providing identification when precise angle measurement reveals a particular image or other data.

The very shape of the structures contoured in the substrate by the energy source can also be used to provide a form of encoding. This may result in image distortion, but such distortion may be covered by other techniques to enhance the image.

Another way of encoding the data in addition to the image data, is to provide minor contours on the substrate between grooves or troughs that constitute the diffraction grating for the image. Such minor contouring can contain either a digital or analog code that can be detected (if known) when viewing the resulting image on the substrate. Programming for this secondary contouring between the main image troughs, can be accomplished in the same way that central processor 4 programmed to provide instructions for carrying out the contouring for the image.

In another embodiment of the present invention, the line structure need not be formed by focusing a laser, as depicted in FIG. 2. Rather, a line on the substrate can be formed by using a series of dots placed on the substrate by a laser stylus. For purposes of establishing a base of reference, and a usable example, pixels are considered. However, other microstructures can be formed using the inventive process.

In the present example, a pixel or local writing area (LWA) to be written is approximately 100 microns across in a substantially circular shape. The pixel will be constituted by sixty lines, where in each line is constituted by a diffraction grating, as approximately depicted in FIG. 8. The stylus is a laser beam E3 approximately three microns in diameter. Each of the lines will be exposed to sixty “dots” from the stylus. In this manner, it is clear that the exposure areas or dots will overlap along the line that they are forming.

In operation, the laser source is pulsed in an on-off sequence. Modulation is achieved by varying the power level during the “on” portion of the sequence. Additional modulation can be achieved by varying the standard x-y axis scanning routine so that the exposure “dots” are overlapping or have varying distances between them. In this manner, any variety of line or trough depth or shape (such as those depicted in 5 and 6) can be achieved. This process of writing individual lines or troughs in a diffraction grating can be carried out quickly and efficiently simply by the appropriate programming for the control system operating the laser and the scanning arrangement. Masks and special optics are not needed in this embodiment.

By using this arrangement, individual pixels or other microstructures can be specially configured, even if the original image data did not contain the characteristics desired for the final product. Thus, the image can be configured as desired, and can contain additional data such as encoding data. Variations are carried out not just in the x and y directions (as is done with conventional systems), but with full use of alterations in the z axis (into the depth of the substrate).

The present invention facilitates that the scanning of a modulated laser line (depicted as E3 in FIGS. 7(a), 7(b)) over a scanning field 200 or as depicted in FIG. 8). It should be noted that the scanning field 200 as shown as a series of rectangular structures. However, this is merely for purposes of depicting the field. The shapes of the contoured structures within each of the blocks of the scanning field can be any shape desired.

By sweeping or scanning the modulated laser line E3 over the scanning field 200, a wide variety of different reliefs and contours can result as desired. This means that a wide variety of different structures can also be achieved.

Modulation of laser line E3 is achieved by pulsed-operation of the laser at various power levels. This effects various depths of penetration into sub-depth of substrate 19 (along the z axis). The variations and penetration are depicted as being along a single line of the x axis. The modulated line can be envisioned as sweeping upwards out of the paper (in the y axis) in order to provide a scanning along the entirety of the x-y scan field depicted in FIG. 8. It should be understood that for each position along each of the boxes depicted in FIG. 8, the power of the beam E3 can be adjusted as needed. Further, the exposure dots created by the laser E3 can also be overlapped in order to affect smoother transitions from one eradiation point to another.

By sweeping or scanning the modulated laser line E3 over the scanning field 200, a wide variety of different reliefs and contours can result as desired. This means that a wide variety of different structures can also be achieved. The result is a system in which virtually any shape of microstructure can be achieved.

It should be understood that there are a number of different optical devices and techniques that can be used to achieve the manipulations carried out in the process of the present invention. For example, modulation can be carried out by any number of different optical elements or a liquid crystal device. Switching can be carried out mechanically or electronically. Any number of different optical elements can also be used for shaping, focusing, or spreading energy from source 1 into the required irradiation configuration E2, E3.

It should be noted that scanning in the traditional sense used with reference to holography where the manufacturer of Fresnel lens is not necessary to the operation of the present invention, although it can be incorporated therein. Rather, the irradiation line E2 can be placed at virtually any angle with respect to the last line irritating the substrate 19. For example, two sequentially irradiated lines can be at right angles (or virtually any other angle) with respect to each other. Nor do the irradiation lines have to be placed in any particular sequence. Rather, the platen 9 can be moved or manipulated in such a manner that irradiation lines contour the substrate 19 in any number of different directions or sequences. Thus, traditional scanning is not a requirement of the present invention, but merely an adjunct thereof.

While reference has been made to the creation of pixels, as a means of reference for the creation of microstructures, the present invention is not limited thereto. Rather, the present invention can operate in a manner that appears to be continuous of radiation along the irradiating line E3 (as depicted in FIGS. 7(a) and 7(b). Rather, many microstructures are effectively and more efficiently created with the constant exposure to line radiation. For example, lens with smooth curvatures are best created using a continuous irradiation and movement of the irradiating line E3 over the substrate to be contoured.

It should be noted that the generalized system depicted in FIG. 1 is simply one system that can be used to carry out the present invention. There are a wide variety of different types of systems that could be used to conduct the process of the present invention. In particular, the key functionality of modulating the laser line E3 can be carried out using an LED screen or any other light modulating device, such as a Texan Instruments than DLP (using a larger array of micro-mirrors), a Holoeye Spatial light modulator, or any number of other MEMS devices. It is important to note that the particular physical devices, instruments, or arrangements are not crucial as long as the key functionality of the present invention can be carried out.

While a number of embodiments have been disclosed by way of example, the present invention is not limited thereby. Rather, the present invention should be understood to include any and all variations, adaptations, modifications, permutations, derivations and embodiments that would occur to one skilled in this art and in possession of the present invention. Accordingly, the present invention should be construed as being only by the following claims.

I claim:

1. A method of contouring a substrate to write data, comprising the step of:
a) forming a single energy beam into a line configuration, and
b) selectively modulating energy levels long said line to contour depth of said substrate to form a selected relief pattern.
